(19) United States
(12) Patent Application Publication
(10) Pub. No.: US 2023/0405402 A1
(43) Pub. Date: Dec. 21, 2023

(54) A TOOL MOVEMENT ANALYSIS SYSTEM AND METHOD

(71) Applicant: Eaton Intelligent Power Limited, Dublin 4 (IE)

(72) Inventors: Daniel ZUCCHETTO, Dublin (IE); Padhraig RYAN, Keatingstown (IE)

(21) Appl. No.: 18/251,184

(22) PCT Filed: Nov. 5, 2020
(86) PCT No.: PCT/EP2020/081030

§ 371 Date: Apr. 28, 2023

(51) Int. Cl. A63B 24/00; A63B 71/06; A63B 60/46

(52) U.S. Cl. CPC A63B 24/0006; A63B 71/0622; A63B 60/46; A63B 2220/803; A63B 2220/833; A63B 2220/836; A63B 2102/32

(57) ABSTRACT

One of the most important factors affecting the performance of athletes in club, bat or racket based sports is the athlete's swing or sporting action with their club, bat or racket. Minor changes in swing path and speed can have a significant impact on the outcome of a shot or other sporting action. As there are many factors affecting shot outcomes and small changes in the athlete's swing can have a large impact on the shot outcome, it is difficult for inexperienced athletes and coaches to correctly diagnose and fix grip faults. The present disclosure provides a tool movement analysis system 10 comprising a tool sensor positionable on a tool, a body sensor positionable on a user, and a processor configured and operable to collect and analyse data related to the user's movement with the tool and provide relevant feedback to the user.

### FIELD OF THE DISCLOSURE

The present disclosure relates to a tool movement analysis system and method and finds particular, although not exclusive, utility in a system and method for providing an athlete, such as a golfer or tennis player, with feedback related to their sporting action, such as a golf or tennis swing, with their sports equipment, such as a golf club or tennis racket.

### BACKGROUND TO THE DISCLOSURE

One of the most important factors affecting the performance of athletes in club, bat or racket based sports is the athlete's swing or sporting action with their club, bat or racket. Minor changes in swing path and speed can have a significant impact on the outcome of a shot or other sporting action. For example, in golf, a shot taken with a change in swing path, such as from a so called in to out swing path to a so called out to in swing path, may result in a significant change in position of the ball after the shot. Golfers, along with other athletes, may vary their swing or sporting action depending on their desired shot outcome. Typically, athletes understand that altering their swing will alter the shape, flight, direction and distance of their shot. Some athletes may aim to use a highly consistent swing whilst altering some other aspect of their set-up, such as their grip, to achieve different shot outcomes.

A so-called neutral swing path or a so-called in to out swing path are typically preferred when compared to a so-called out to in swing path. An out to in swing path typically results in a lower launch angle of a golf ball, a relatively high amount of backspin, and a relatively high amount of side spin. These factors all reduce the distance of a golf shot and may also reduce the accuracy of a golf shot. In particular, an out to in swing path may result in a sliced shot wherein, for a right handed golfer, the ball curves wildly to the right in flight with significantly reduced distance. Accordingly, the athlete's swing path or sporting action has a large impact on the shot outcome.

Typically, athletes receive feedback on their grip, and the resulting shot, through coaching or practice, often including video feedback. However, the athlete's swing is not the only factor that affects the outcome of their shot. For example, the athlete's grip on their club and environmental factors such as wind also have a significant effect on the outcome of the shot. As there are many factors affecting shot outcomes and small changes in the athlete's swing can have a large impact on the shot outcome, it is difficult for inexperienced athletes and coaches to correctly diagnose and fix grip faults. Furthermore, even elite level athletes and coaches may find it difficult to correctly diagnose and fix swing faults.

Therefore, it is desirable to provide a tool movement analysis system and method capable of providing feedback related to a user's movement of a tool, such as a golf club or a tennis racket. Objects and aspects of the present disclosure seek to provide such a system and method.

### SUMMARY OF THE DISCLOSURE

According to a first aspect of the present disclosure, there is provided a tool movement analysis system comprising: a tool sensor positionable, in use, on a tool configured and arranged for movement by a user; a body sensor positionable, in use, on a user; and a processor configured and operable to: detect, with the tool sensor, an arrangement of the tool; compare the detected arrangement of the tool with a predetermined position of the tool; determine if the detected arrangement of the tool matches the predetermined position of the tool; receive movement data related to an action of the user with the tool for a time period following the determination of the detected arrangement of the tool matching the predetermined position of the tool, wherein the movement data includes tool sensor data from the tool sensor and body sensor data from the body sensor; analyse the movement data and determine a predetermined event of interest has occurred; and output, to a feedback device, a feedback output related to the movement data.

A key advantage of the present disclosure is that the system may provide a user with feedback related to their movement of a tool and their body. In particular, the system may provide a user with feedback related to a particular movement of interest, such as a golf swing or other sporting action. Furthermore, the user may use the feedback provided by the present disclosure to adjust their movement of the tool, such as their movement speed, position or force applied. The feedback may, for example, be visual, audible or tactile.

The tool may be a golf club. The tool movement may be a golf swing. Accordingly the feedback output may relate to a user's golf swing. For example, the feedback output may indicate that the user has swung, or consistently swings, a golf club along a so-called out to in swing path. Alternatively, or additionally, the feedback output may indicate that the user is releasing the golf club, wherein the relative angle between a golfer's forearm and the shaft of the golf club increases from approximately 90° to approximately 180°, too soon in their golf swing.

Alternatively, the tool may be another piece of sports equipment, such as a baseball bat, a tennis racket, a badminton racket, a cricket bat, a hockey stick, a hurley, a lacrosse stick, a table tennis paddle, a fishing rod, or any other known sports equipment configured to be held by a user. The tool movement may be a sporting action, such as a tennis swing or a cast with a fishing rod. Accordingly, a user may obtain some feedback related to their movement of the sports equipment and the associated sporting action.

Alternatively, the tool may be a training aid for an automated system, such as a robotic arm or other mechanical device configured to grip and move an object. The tool movement may be an automated system training movement. The automated system may be programmed to grip the training aid and move it. The tool movement analysis system may then provide feedback related to the movement of the training aid by the automated system. Accordingly, the automated system may be programmed to grip and move an object in a desired way.

As a further alternative, the tool may be a medical device. The medical device may be intended for use during a medical procedure such as in detecting a medical issue, such as a neurological or physiological issue. For example, a user may be asked to grip and move the medical device in a certain way, and the feedback output may be used to determine whether the user's movement of the tool is as intended, or if some neurological issue exists. A difference between the user's movement of the tool and the intended movement of the tool may indicate a neurological or other medical issue.

Alternatively, the tool may be a crafting or working tool, such as a craft knife or a handheld drill. The tool movement may be a crafting or working action. A user may grip and move the tool whilst operating or using the tool. The user may find that a particular movement results in an improved outcome from operation of the tool. Accordingly, the system may be used to allow the user to adjust their movement until they find a movement which provides preferable results, and use the feedback output to train and recreate said movement.

The tool sensor and/or the body sensor may comprise an accelerometer, a gyroscope, a magnetometer, a tilt sensor, a tactile pressure sensor and/or any other suitable sensor. In this way, data related to the movement of the tool or the user's body may be captured and subsequently processed.

The tool sensor may be positionable on an interior or an exterior of the tool. The tool sensor may be attachable to the tool. The tool sensor may be releasably attachable to the tool. For example, the tool sensor may comprise a releasable clamp or some other releasable fixing that may be used to attach the tool sensor to the tool. The system may comprise a plurality of distributed tool sensors.

The body sensor may be attachable directly to the user. Alternatively, or additionally, the body sensor may be attachable to an item of clothing or an accessory worn by the user. For example, the body sensor may be attachable to, or integral with, a glove, a shirt, trousers, a cap, a shoe or shoes, glasses, a watch, a wrist band and/or any other suitable piece of clothing or accessory. The placement of the body sensor may be dependent on the action to be performed. For example, in golf it is generally considered important to keep the head steady or still during most of a golf swing, and a sensor placed on a cap, headband or glasses may be suitable for detecting head movement. The system may comprise a plurality of distributed body sensors.

The predetermined position of the tool may be a position in which the tool is expected to be arranged prior to an action taking place. For example, in golf, an address position is typically assumed before a golf swing occurs. The address position involves arranging the golf club with the club head lowermost adjacent to the ground, with the user stood still with their hands adjacent one another on the grip of the golf club. As further examples, the predetermined position may be the position in which a user arranges themselves and their racket prior to serving in tennis or badminton.

The time period may be sufficient for an expecting action with the tool to be performed. For example, in golf, the time between assuming the address position and finishing a swing is typically less than 10 seconds. The time period may therefore be 10 seconds such that data related to the entire golf swing is captured. The time period may be adjustable or adjusted dependent on the expected action and/or previous similar actions by the user. For example, a golfer may take significantly longer than average to complete a swing after assuming the address position, and the time period may be increased accordingly.

The processor may be configured to determine an orientation and/or a displacement of the tool sensor and/or an orientation and/or a displacement of the body sensor during the event of interest. The feedback output may include the orientation and/or displacement of the tool sensor and/or the body sensor. In this way, the user may be provided with feedback related to their movement of the tool and/or their body during the sporting action or other event of interest.

The processor may be configured to continuously determine the orientation and/or displacement of the tool sensor and/or the body sensor throughout a duration of the event of interest. The feedback output may include a plurality of orientations and/or displacements for one or each of the tool sensor and the body sensor as a function of time. The feedback output may include a continuous output of the orientation and/or displacement. In this way, the user may be provided with feedback related to their entire sporting action.

The tool movement analysis system may comprise a plurality of body sensors. Each of the plurality of body sensors may be positionable, in use, on a user at a position spaced from each of the other plurality of body sensors. In this way, data related to the position and/or movement of a plurality of body parts or body locations may be captured and subsequently processed.

The body sensors may be positionable, in use, on a garment worn by a user. The body sensor may include a stiffening member. The stiffening member may be positionable on the garment adjacent to the body sensor and may be arranged to stiffen the garment adjacent to the body sensor. In this way, the garment may be made relatively more rigid adjacent to the body sensor, thereby increasing or enhancing the signal to noise ratio of the data by limiting movement of the body sensors due to flexible garments. The stiffening member may include a relatively stiff net. The net may be integral with or otherwise attached to the garment in the region of the body sensor. Accordingly, a user may still transpire through the net, which may result in a more comfortable garment.

Detecting if the arrangement of the tool matches the predetermined position of the tool may mean that the processor detects or identifies the tool as being in the predetermined position. The tool being in the predetermined position may be indicative of an action of interest with the tool being imminent. The processor may be configured to determine if the detected arrangement of the tool falls within a predetermined threshold range of predetermined positions of the tool. The threshold range may include a range of angles, orientations and/or positions relative to the user. In this way, minor changes in starting position of the tool may not result in an event of interest being missed.

The processor may be a processing hub. The processing hub may comprise a plurality of distributed processors. One or each of the tool sensor and the body sensor may be controlled by one or more of the plurality of distributed processors. In this way, data processing may be distributed among the plurality of distributed processors which may increase processing speed to real-time or near real-time, and may also reduce the amount of raw or unprocessed data to be transmitted.

The tool movement analysis system may be arranged such that, if the processor determines the detected arrangement of the tool matches the predetermined position of the tool, the body sensor is switched from a power conservation mode to an active mode by the one or more distributed processors associated with the tool sensor. In this way, the power consumption of the body sensor may be reduced. Accordingly, the body sensor may require charging less often and/or a smaller and lighter power source, such as a rechargeable battery or capacitor, may be provided with the body sensor.

The one or more distributed processors associated with the tool sensor may be configured to switch the body sensor from the active mode to the power conservation mode if no occurrence of a predetermined event of interest is detected within a predetermined time of the body sensor being switched to the active mode. In this way, the power consumption of the body sensor may be reduced.

One or each of the plurality of distributed processors may be configured to locally calculate and store, in a memory, an orientation and displacement of the associated tool sensor or the body sensor. The memory may be a local memory associated with the respective one of the plurality of distributed processors. In this way, data may be stored and processed locally to reduce the amount of raw or unprocessed data to be transmitted. Alternatively, or additionally, a global memory may be provided and may be accessible by each of the plurality of distributed processors.

One or each of the plurality of distributed processors may be configured to analyse tool sensor data or body sensor data from the associated sensor and may be further configured to determine the predetermined event of interest has occurred based on the tool sensor data or body sensor data from the associated sensor. The determination may be made based on a pre-trained machine learning model. A particular movement or sequence of movements of the tool sensor or body sensor may indicate the event of interest has occurred.

One or each of the plurality of distributed processors may be configured to determine the predetermined event of interest has occurred by analysing the tool sensor data or body sensor data with a machine learning model. The processor and/or the plurality of distributed processors may be configured to determine if the detected arrangement of the tool matches the predetermined position of the tool with a further machine learning model. In this way, the system may become more accurate and/or more suited to the user through use. The processor and/or plurality of distributed processors may be configured to process data with a consensus algorithm, a Mahony algorithm and/or any other suitable algorithm or process.

The plurality of distributed processors may mutually communicate and determine that their relative positions has changed between two events of interest. The operation of the processor and/or plurality of distributed processors may be adjusted accordingly.

The processor may be configured to determine a predetermined event of interest has occurred if a predetermined threshold number of the plurality of distributed processors determine a predetermined event of interest has occurred. The threshold number may be less than the total number. In this way, an event of interest may be identified even if one or more of the plurality of distributed processors is malfunctioning or otherwise does not detect that an event of interest has occurred. The threshold number of the plurality of distributed processors may be half the total number of distributed processors. Any other suitable threshold number may be used, and may be dependent on the application of the system. The threshold number may be adjustable by a user or by the system with a machine learning model.

The processor may be operable to delete at least a portion of stored movement data if less than the threshold number of the plurality of distributed processors determine a predetermined event of interest has occurred. In this way, irrelevant or otherwise unwanted data may be deleted so as not to use memory space. Accordingly, a relatively smaller memory may be provided.

The processor may be operable to use a predictive model to identify the event of interest. In this way, the system may link or connect the data more accurately, quickly and/or efficiently.

The processor may be operable to continually store, in a memory, the movement data. As such, a continuous stream of data may be captured and stored for processing and providing a continuous feedback to the user. The processor may be operable to delete data captured outside of a predetermined time preceding the determining of the detected arrangement of the tool matching the predetermined position of the tool. The processor may be operable to delete data captured outside of a predetermined time preceding the determining of the predetermined event of interest occurring. In this way, irrelevant or otherwise unwanted data may be deleted.

The system may be configured to provide feedback to the user in real time. Alternatively, or additionally, the system may be configured to provide historical data to a user. In this way, the user may track their progress or recall and recreate previous one or more user control configurations saved in the historical data. The one or more user control configurations may comprise one or more of the following: a grip, a movement, a body movement, a tool movement, a swing, and a tool manipulation.

The feedback device may be operable to provide a user with feedback related to the movement of the tool or their body. The feedback device may be operably connected to the processor. The feedback device may be physically or wirelessly connected to the processor. The feedback device may be adjacent the tool and/or may be positionable adjacent to the user's body. For example, the feedback device may be on, embedded into, or under a golf grip on a golf club. Alternatively, the feedback device may be standalone, such as a smartphone or some other device with a display or loudspeaker.

The feedback device may comprise a haptic feedback device. The haptic feedback device may be operable to provide a user gripping the tool with haptic feedback. Haptic feedback may be any form of feedback that the user is able to feel. The haptic feedback device may be on the tool, particularly in a region intended to be held by the user, in use. As such, the feedback device may provide a user holding the tool with feedback via their hands. The haptic feedback device may be configured to operate by changing temperature, applying force, vibrating, or any other form of mechanical motion, and/or otherwise actuating to provide feedback. The haptic feedback device may be distributed across a portion of the tool. Alternatively, the haptic feedback device may be positioned on a wearable object, such as a wristband, an arm band or a glove.

Alternatively or additionally, the feedback device may comprise a visual feedback device operable to provide a user with visual feedback. The visual feedback device may comprise a display. The display may be wearable, such as eyewear, or standalone. The visual feedback device may comprise a smart phone or a smart watch. For example, the smart phone or smart watch screen may be used to provide visual feedback.

Alternatively or additionally, the feedback device may comprise an audible feedback device operable to provide a user with audible feedback. The audible feedback device may comprise a speaker. The speaker may comprise a loudspeaker, headphones and/or earphones.

According to a second aspect of the present disclosure, there is provided a tool movement analysis method comprising the steps: detecting, with a tool sensor positionable, in use, on a tool configured and arranged for movement by a user, an arrangement of the tool; comparing the detected arrangement of the tool with a predetermined position of the tool; determining if the detected arrangement of the tool matches the predetermined position of the tool; receiving movement data related to an action of the user with the tool for a time period following the determination of the detected arrangement of the tool matching the predetermined position of the tool, wherein the movement data includes tool sensor data from the tool sensor and body sensor data from a body sensor positionable, in use, on a user; analysing the movement data and determining a predetermined event of interest has occurred; and outputting, to a feedback device, a feedback output related to the movement data.

The tool movement analysis method may include each or every step carried out during operation of the processor of the first aspect. Accordingly, each feature of the first aspect may be included in the second aspect of the present disclosure.

### BRIEF DESCRIPTION OF THE DRAWINGS

The disclosure will now be described, by way of example only, with reference to the accompanying drawings, in which:

FIG. 1 is a diagram of a golf swing analysis system on a user;

FIG. 2 is a system block diagram of a first step of a tool movement analysis method;

FIG. 3 is a system block diagram of a second step of the tool movement analysis method;

FIG. 4 is a system block diagram of a third step of the tool movement analysis method;

FIG. 5 is a system block diagram of a fourth step of the tool movement analysis method; and

FIG. 6 is a system block diagram of a fifth step of the tool movement analysis method.

### DETAILED DESCRIPTION

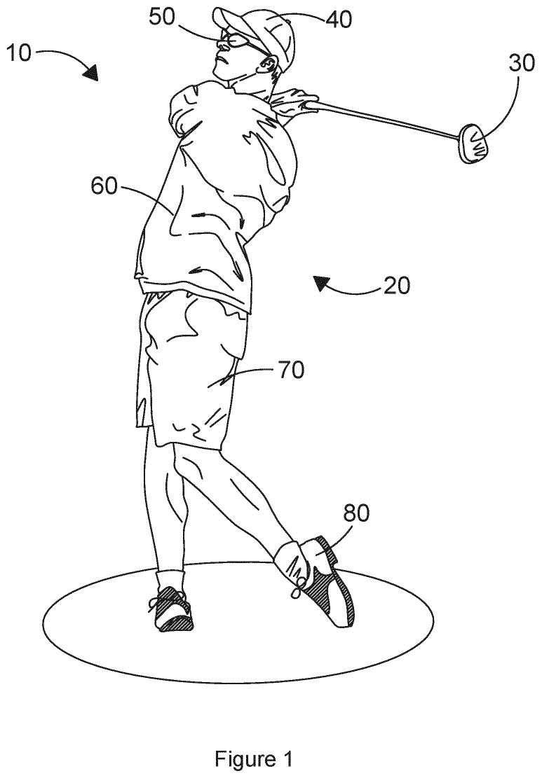

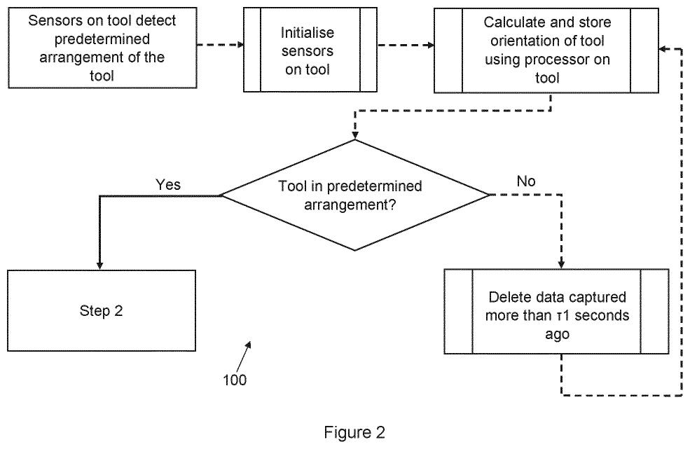

FIG. 1 is a diagram of a golf swing analysis system 10 in use by a user 20. The user 20 is a golfer and is shown to be in the follow through position after completing a golf swing with a golf club 30. The golf swing analysis system 10 includes a plurality of sensors, such as accelerometers or magnetometers, and associated processors which are arranged in positions such that movement data relevant to golf is captured. The movement of the golf club 30 has a significant effect on the outcome of the golf swing. As such, a sensor may be positioned on the golf club 30 to capture data related to the position and/or movement of the golf club 30. In golf, it is typically taught that a user's head should remain relatively still until after the ball has been hit. Accordingly, a sensor and associated processor may be placed on a user's cap 40 and/or glasses 50 to capture data related to the position and/or movement of the user's head. Furthermore, the twisting or opening of a user's body during a golf swing is typically considered to be important in a golf swing. Therefore, a sensor may be positioned on a user's shirt 60 and/or shorts 70 or trousers to capture data related to the position and/or movement of the user's body and legs. Furthermore, the position and movement, or lack thereof, of a user's feet during a golf swing is typically considered to be important. Accordingly, a sensor or sensors may be positioned on the user's shoe 80 or shoes to capture data related to the position and/or movement of the user's feet during the golf swing. The processors of the golf swing analysis system 10 are configured and arranged to analyse, share and feedback the captured data to the user 20. In particular, the golf swing analysis system may be configured to carry out the tool movement analysis system as described with reference to FIGS. 2 to 6.

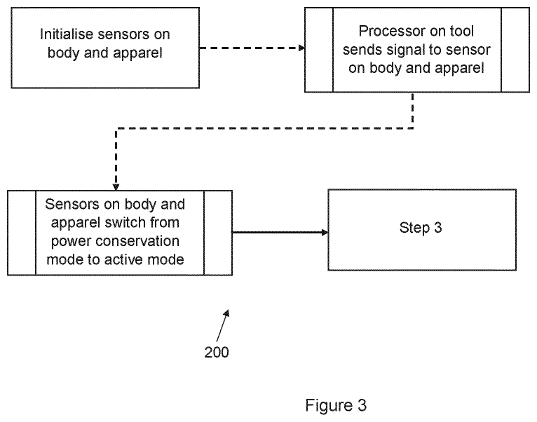

FIG. 2 is a system block diagram of a first step 100 of a tool movement analysis method. The first step 100 includes detecting, with sensors on the tool, if the tool is arranged in a predetermined arrangement. To activate the tool analysis system and initiate the tool analysis method, the user may press a button arranged on the system. Alternatively, the system may be arranged in a standby mode or a low-power mode, and the user may initialise sensor data collection by sending a wireless signal from a device such as a smart phone, smart watch, or any other suitable device. The device may be configured to collect sensor data at a low rate, and the user may arrange the tool, for example the golf club 30 shown in FIG. 1 or another piece of sports equipment, in the predetermined arrangement in order to trigger an increase in the sampling rate to that needed for analysis of a potential event. In golf, the predetermined arrangement may be an address position in which the golf club is arranged with the club head lowermost adjacent to the ground and wherein the user is stood still with their hands adjacent one another on the grip of the golf club. The tool sensors are initialised and the tool sensors may then capture, and store in an associated memory, data related to the orientation of the tool. The data is then analysed to determine if the tool is positioned in the predetermined arrangement. If it is determined that the tool is not arranged in the predetermined position, data captured more than T1 seconds ago is deleted from the associated memory in order to save memory space. The time T1 may be dependent on the tool and the movement being performed with the tool. For example, the time T1 may be 1, 5, 10 or 15 seconds or any other suitable length of time. If it is determined that the tool is arranged in the predetermined position, step 2 of the method is carried out, as described in relation to FIG. 3.

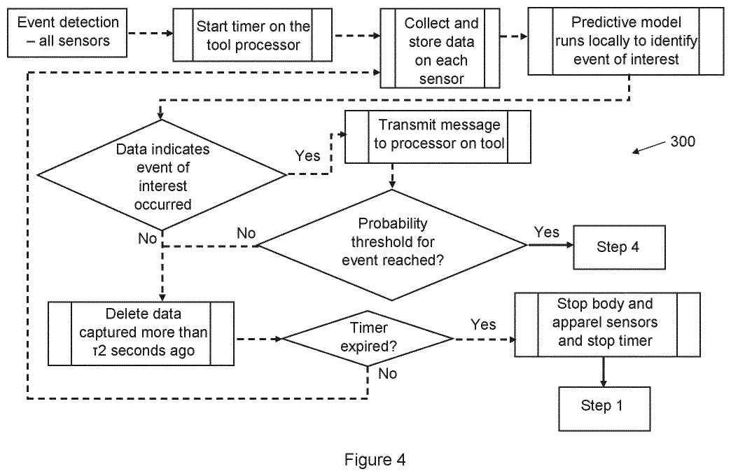

FIG. 3 is a system block diagram of a second step 200 of the tool movement analysis method. Once it is determined that the tool is arranged in the predetermined position, the sensors on the user's body and the user's apparel are initialised. To initialise said sensors, a processor associated with the tool sensors send a signal to the sensors on the user's body and on the user's apparel. The sensors on the user's body and the user's apparel are then switched from a power conservation mode or a low power mode to an active mode. Then, step 3 is carried out, as described in relation to FIG. 4.

FIG. 4 is a system block diagram of a third step 300 of the tool movement analysis method. After the sensors on the user's body and apparel are switched to an active mode in step 2, they are ready and able to collect and store data. First, a timer is started on the processor associated with the sensor on the tool to count down a predetermined time in which an event of interest is expected to occur. Data is collected and stored by each of the sensors in use, and a predictive model is run locally at each sensor to identify an event of interest. Accordingly, the event of interest taking place is determined by each processor independently based only on the data captured by said processor.

If no data indicates an event of interest has occurred, data captured more than T2 seconds ago is deleted, to save memory space. T1 and T2 may be separate and independent, alternatively T1 and T2 may comprise the same counter. The timer is then consulted and if the timer has expired, the timer is stopped and the body and apparel sensors are switched back to the power conservation mode, and step 1 of the method is started. If the timer has not expired, further data is collected and processed as described above until an event of interest is identified or the timer expires.

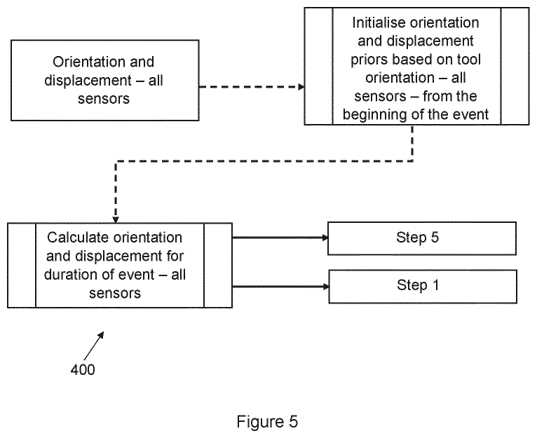

If some data indicates an event of interest has occurred, the relevant sensor and associated processor sends a message to the processor associated with the sensor on the tool. If messages are received indicating an event of interest has occurred from a number of sensors that exceeds a predetermined threshold number, step 4 as described with reference to FIG. 5 is carried out. The threshold number may be any suitable number, such as half of the total number of sensors, and may be selectable by the user. If messages are received indicating an event of interest has occurred from a number of sensors that does not exceed the predetermined threshold number, data captured more than T2 seconds ago is deleted, to save memory space. The timer is then consulted and if the timer has expired, the timer is stopped and the body and apparel sensors are switched back to the power conservation mode, and step 1 of the method is started. If the timer has not expired, further data is collected and processed as described above until an event of interest is identified or the timer expires.

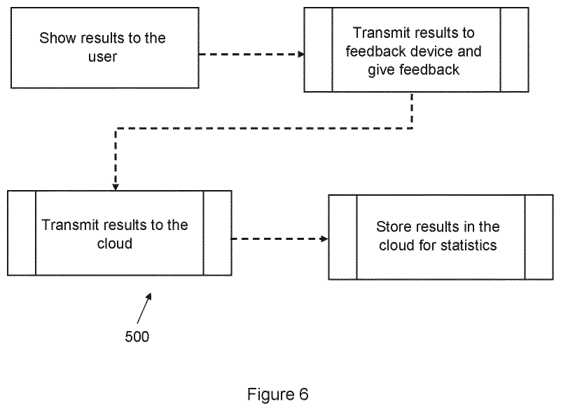

FIG. 5 is a system block diagram of a fourth step 400 of the tool movement analysis method. The fourth step 400 includes determining and calculating the orientation and displacement of the tool sensors and the sensors positioned on the user. Once the probability threshold for an event of interest is determined in step 3, the orientation and displacement priors based on the tool orientation are initialised for all sensors from the beginning of the event of interest. The orientation and displacement for each of the sensors for the duration of the event of interest may therefore be obtained. These results may then be passed onward to step 5, as described with reference to FIG. 6. Furthermore, the method may restart from step 1, as described with reference to FIG. 2.

FIG. 6 is a system block diagram of a fifth step 500 of the tool movement analysis method. After the orientation and displacement of the sensors, and therefore the tool and the user's body, are calculated, relevant results are obtained. The results may be shown to the user. In particular, the results may be transmitted to a feedback device to give feedback to the user. The feedback device may comprise a display to give visual feedback to the user. Alternatively, or additionally, the feedback device may comprise a haptic feedback device to give haptic feedback to the user. Furthermore, the results may be transmitted and stored in the cloud or some other accessible storage system. The user may then access their results, both recent and historic, to track their progress and view any improvements in their movement with the tool.

Although golf has been used as an example of an application of the system and method described herein, the system and method may also be applied to any user movement involving a tool. For example, another type of sporting action, such as a tennis serve, or a crafting action, such as the use of a crafting knife, may be analysed. The associated predetermined arrangement and timings may be adjusted and selected appropriately. Additionally, although FIG. 1 shows sensors positioned on the user's cap, glasses, shirt, shorts and shoe, not all of these are necessary. Only one, or more than one but less than the total number, sensor may be provided. Other positions for sensors are envisaged. For example, a sensor may be positioned on a belt to capture data related to the movement of a user's hips, or on a glove to capture data related to the movement of a user's hand. The selection of a position for a sensor may be dependent on the movement expected from the user. The positions described herein in relation to golf may not be appropriate for another movement, such as a crafting movement. Furthermore, several steps described in FIGS. 2 to 6 are optional, as will be clear from the disclosure of the claimed disclosure, and are included for clarity purposes only.

1. A tool movement analysis system comprising:
a tool sensor positionable, in use, on a tool configured and arranged for movement by a user;
a body sensor positionable, in use, on a user; and
a processor configured and operable to:
detect, with the tool sensor, an arrangement of the tool;
compare the detected arrangement of the tool with a predetermined position of the tool;
determine if the detected arrangement of the tool matches the predetermined position of the tool;
receive movement data related to an action of the user with the tool for a time period following the determination of the detected arrangement of the tool matching the predetermined position of the tool, wherein the movement data includes tool sensor data from the tool sensor and body sensor data from the body sensor;
analyse the movement data and determine a predetermined event of interest has occurred; and,
output, to a feedback device, a feedback output related to the movement data.

2. The tool movement analysis system of claim 1, wherein the processor is configured to determine an orientation and a displacement of the tool sensor and an orientation and a displacement of the body sensor during the event of interest, and wherein the feedback output includes the orientations and displacements of the tool sensor and the body sensor.

3. The tool movement analysis system of claim 2, wherein the processor is configured to continuously determine the orientation and displacement of the tool sensor and the body sensor throughout a duration of the event of interest, and the feedback output includes a plurality of orientations and displacements for each of the tool sensor and the body sensor as a function of time.

4. The tool movement analysis system of claim 1, comprising a plurality of body sensors, wherein each of the plurality of body sensors are positionable, in use, on a user at a position spaced from each of the other plurality of body sensors.

5. The tool movement analysis system of claim 1, wherein the body sensors are positionable, in use, on a garment worn by a user, and the body sensor includes a stiffening member positionable on the garment adjacent to the body sensor and arranged to stiffen the garment adjacent to the body sensor.

6. The tool movement analysis system of claim 1, wherein the processor is configured to determine if the detected arrangement of the tool falls within a predetermined threshold range of predetermined positions of the tool.

7. The tool movement analysis system of claim 1, wherein the processor is a processing hub comprising a plurality of distributed processors, wherein each of the tool sensor and the body sensor is controlled by one or more of the plurality of distributed processors.

8. The tool movement analysis system of claim 7, wherein, if the processor determines the detected arrangement of the tool matches the predetermined position of the tool, the body sensor is switched from a power conservation mode to an active mode by the one or more distributed processors associated with the tool sensor.

9. The tool movement analysis system of claim 8, wherein the one or more distributed processors associated with the tool sensor is configured to switch the body sensor from the active mode to the power conservation mode if no occurrence of a predetermined event of interest is detected within a predetermined time of the body sensor being switched to the active mode.

10. The tool movement analysis system of claim 7, wherein each of the plurality of distributed processors are configured to locally calculate and store, in a memory, an orientation and displacement of the associated tool sensor or the body sensor.

11. The tool movement analysis system of claim 7, wherein each of the plurality of distributed processors are configured to analyse tool sensor data or body sensor 18 data from the associated sensor and determine the predetermined event of interest has occurred based on the tool sensor data or body sensor data from the associated sensor.

12. The tool movement analysis system of claim 11, wherein each of the plurality of distributed processors are configured to determine the predetermined event of interest has occurred by analysing the tool sensor data or body sensor data with a machine learning model.

13. The tool movement analysis system of claim 11, wherein the processor is configured to determine a predetermined event of interest has occurred if a predetermined threshold number of the plurality of distributed processors determine a predetermined event of interest has occurred.

14. The tool movement analysis system of claim 13, wherein the threshold number of the plurality of distributed processors is half the total number of distributed processors.

15. The tool movement analysis system of claim 13, wherein the processor is operable to delete at least a portion of stored movement data if less than the threshold number of the plurality of distributed processors determine a predetermined event of interest has occurred.

16. The tool movement analysis system of claim 1, wherein the processor is operable to use a predictive model to identify the event of interest.

17. The tool movement analysis system of claim 1, wherein the processor is operable to continually store, in a memory, the movement data.

18. The tool movement analysis system of claim 17, wherein the processor is operable to delete data captured outside of a predetermined time preceding the determining of the detected arrangement of the tool matching the predetermined position of the tool.

19. The tool movement analysis system of claim 17, wherein the processor is operable to delete data captured outside of a predetermined time preceding the determining of the predetermined event of interest occurring.

20. A tool movement analysis method comprising the steps:
detecting, with a tool sensor positionable, in use, on a tool configured and arranged for movement by a user, an arrangement of the tool;
comparing the detected arrangement of the tool with a predetermined position of the tool;
determining if the detected arrangement of the tool matches the predetermined position of the tool;
receiving movement data related to an action of the user with the tool for a time period following the determination of the detected arrangement of the tool matching the predetermined position of the tool, wherein the movement data includes tool sensor data from the tool sensor and body sensor data from a body sensor positionable, in use, on a user;
analysing the movement data and determining a predetermined event of interest has occurred; and,
outputting, to a feedback device, a feedback output related to the movement data.
